(19) United States
(12) Patent Application Publication
(10) Pub. No.: US 2012/0110202 A1
(43) Pub. Date: May 3, 2012

(54) METHOD AND SYSTEM FOR STREAMING MEDIA BROADCASTS OVER A DATA COMMUNICATIONS NETWORK

(76) Inventor: Vladimir NIMAN, Toronto (CA)

(21) Appl. No.: 13/217,801

(22) Filed: Aug. 25, 2011

(30) Foreign Application Priority Data
Oct. 27, 2010 (CA) 2,719,284

(51) Int. Cl. G06F 15/16

(52) U.S. Cl. 709/231

(57) ABSTRACT

A method and system for streaming media broadcasts over a data communications network is provided. Statistics for receiver devices receiving a plurality of media broadcasts from a broadcast source via a set of routing devices over a data communications network are analyzed to determine which of the media broadcasts are popular, each of the receiver devices accessing the streaming media broadcasts via one of the routing devices. The popular media broadcasts are streamed to all of the routing devices. The unpopular media broadcasts are streamed to the routing devices along paths between the broadcast source and the receiver devices tuned into the unpopular media broadcasts.

This application claims priority from Canadian Application No. 2,719,284, filed on Oct. 27, 2010, the contents of which are incorporated herein in their entirety by reference.

### FIELD OF THE INVENTION

The present invention relates generally to data communications. In particular, the invention relates to a method and system for streaming media broadcasts over a data communications network.

### BACKGROUND OF THE INVENTION

Media broadcasting is known. A television or radio broadcast representing “live” content is transmitted via one or more broadcasting towers or satellites, received using an appropriate receiver, such as a television or a radio, and played back to a user. Alternatively, the television or radio broadcast can be transmitted via a purpose-built wired broadcast infrastructure, such as a cable network.

More recently, live content has been broadcast as “streaming” media via general-purpose data communications networks. The live content is encoded for transmission over an Internet Protocol (“IP”) network such as the Internet, typically via a stateless transport protocol such as user datagram protocol (“UDP”). Video can be encoded using one of many formats, such as H.264, more commonly referred to as MPEG-4 (“Moving Picture Experts Group-4”) or Advanced Video Coding (“AVC”). Similarly, audio can be encoded using one or many formats, such as, for example, Real Media's RealAudio. Users typically receive, decode and play back the streaming media using a general-purpose computer.

Typically, such streaming media is broadcast by a broadcaster separately to each recipient requesting the streaming media due to the seemingly random network topological location of the recipients. This approach is commonly referred to as “unicast”. Unicast does not, however, scale well when many users want to view the same program concurrently, as large volumes of redundant data is transmitted over the same communication links.

Multicast protocols, such as IP Multicast, were developed to reduce the data replication (and consequent server/network loads) that occurs when many recipients receive unicast content streams independently. These protocols send a single stream from the source to a group of recipients. Intermediate routing devices for the data traffic, such as routers and firewalls, then forward the single stream to each adjacent routing device that is along an optimal path to one of the multicast destination addresses. As only a single stream traverses each path in a data communications network, multicast protocols significantly reduce the amount of traffic related to streaming media. Multicast protocols require routing devices to be configured to enable multicasting, thereby allowing the passage of packets destined to multicast recipients. If the routing devices are not configured to enable multicasting, however, the multicast may not be feasible.

It is therefore an object of the invention to provide a novel method and system for streaming media broadcasts over a data communications network.

### SUMMARY OF THE INVENTION

According to an aspect of the invention, there is provided a method for streaming media broadcasts over a data communications network, comprising:

analyzing statistics for receiver devices receiving a plurality of media broadcasts from a broadcast source via a set of routing devices over a data communications network to determine which of said media broadcasts are popular, each of said receiver devices accessing said streaming media broadcasts via one of said routing devices;

streaming said popular media broadcasts to all of said routing devices; and

streaming said unpopular media broadcasts to said routing devices along paths between said broadcast source and said receiver devices tuned into said unpopular media broadcasts.

The analyzing can be performed periodically. The statistics can include the amount of time the receiver devices were tuned into each of the media broadcasts. The analyzing can comprise determining the number of the receiver devices were tuned into each of the media broadcasts for at least a threshold period of time. The analyzing can further include registering a vote, for each of the media broadcasts, if the number of the receiver devices tuned into the media broadcast is at least equal to a threshold. The registering can be performed by the routing devices. Each of the media broadcasts can be deemed popular if the number of votes received from the routing devices for the media broadcast is at least equal to a threshold.

The routing devices can be routers that stream the media broadcasts to other routers via IP tunnels. The IP tunnels can be established using general routing encapsulation (“GRE”). The routers can be arranged in a ring formation. The streaming of the popular media broadcasts can include streaming some of the popular media broadcasts in a first direction around the ring formation of routers, and streaming the balance of the popular media broadcasts in a second direction around the ring formation of routers.

The method can include streaming a subset of the media broadcasts to all of the routing devices regardless of whether the media broadcasts in the subset are popular or unpopular.

The determination of which of the media broadcasts are popular is adjustable, such as by available bandwidth.

According to another aspect of the invention, there is provided a system for streaming media broadcasts over a data communications network, comprising:

a set of routing devices in communication with each other over said data communications network, said set of routing devices receiving a plurality of media broadcasts from a broadcast source; and

a processing unit executing computer-executable instructions configured for determining if each of said media broadcasts is popular using statistics for receiver devices, each of said receiver devices accessing said streaming media broadcasts via one of said routing devices, streaming said popular media broadcasts to all of said routing devices and streaming said unpopular media broadcasts to said routing devices along paths between said broadcast source and said receiver devices tuned into said unpopular media broadcasts.

The processing unit can determine if each of the media broadcasts are popular periodically. The statistics include the amount of time the receiver devices were tuned into each of the media broadcasts.

Each of the media broadcasts can be deemed popular if the number of votes received from the routing devices for the media broadcast is at least equal to a threshold.

The routing devices can be routers. The routers can stream the media broadcasts via IP tunnels between the routers. The routers can be arranged in a ring formation, and the processing unit can stream the popular media broadcasts in a first direction around the ring formation of routers, and can stream the balance of the popular media broadcasts in a second direction around the ring formation of routers.

A subset of the media broadcasts can be streamed to all of the routing devices regardless of whether the media broadcasts in the subset are popular or unpopular.

The determination of which of the media broadcasts are popular can be adjustable. The determination of which of the media broadcasts are popular can be adjusted according to available bandwidth.

### BRIEF DESCRIPTION OF THE DRAWINGS

Embodiments will now be described, by way of example only, with reference to the attached Figures, wherein:

FIG. 1 is a schematic diagram of a high-level architecture of a system for streaming media broadcasts over a data communications network in accordance with an embodiment of the invention and its operating environment;

FIG. 2 shows a schematic diagram of a router of the system of FIG. 1;

FIG. 3 shows a receiver device of FIG. 1 and its immediate operating environment;

FIG. 4 shows the method for streaming media broadcasts over a data communications network used by the system of FIG. 1;

FIG. 5 shows the identification of popular channels for each router in the method of FIG. 4 in greater detail; and

FIG. 6 shows the addition of channels to the multicast elected pool in the method of FIG. 4 in greater detail.

### DETAILED DESCRIPTION OF THE EMBODIMENT

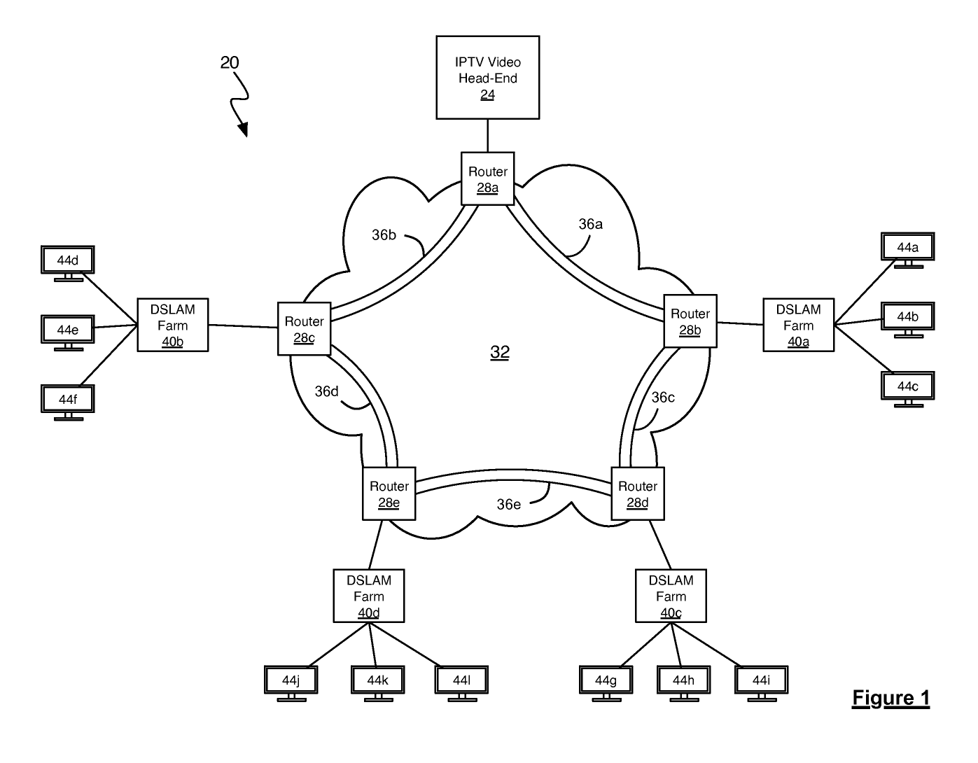

A system 20 for streaming media broadcasts over a data communications network in accordance with an embodiment of the invention is shown in FIG. 1. The system 20 shown is an exemplary configuration for illustrating its components and architecture in a concise manner. The system 20 includes an Internet Protocol Television (“IPTV”) video head-end 24. The IPTV video head-end 24 receives broadcast signals from a broadcaster, including a plurality of discrete broadcast channels. As the broadcast channels are received by the IPTV video head-end 24, it encodes the broadcast channels for streaming over Internet Protocol (“IP”). In particular, the IPTV video head-end 24 encodes each broadcast channel using the H.264 standard, also commonly referred to as MPEG-4 or Advanced Video Coding (“AVC”). H.264 is a block-oriented motion-compensation-based codec standard for video compression developed by the ITU-T Video Coding Experts Group (“VCEG”) together with the ISO/IEC Moving Picture Experts Group (MPEG). The ITU-T H.264 standard and the ISO/IEC MPEG-4 AVC standard (formally, ISO/IEC 14496-10-MPEG-4 Part 10, Advanced Video Coding) are jointly maintained so that they have identical technical content. H.264 is used for encoding videos on Blu-ray Discs, YouTube, Apple's iTunes, Adobe Flash and Microsoft Silverlight. The IPTV video head-end 24 can include one or more computers dedicated to encoding the broadcast channels.

The IPTV video head-end 24 acts as a broadcast source for a plurality of routers 28 distributed over a large IP data communication network 32. In this particular embodiment, the IP data communications network 32 is a large, private network operated by a telecommunications service provider. More specifically, the routers 28 are Cisco™ routers that have processors to execute an operating system/firmware and storage for storing configuration information. While routers are employed in the presently-described embodiment, those of skill in the art will appreciate that other types of routing devices can be employed, such as purpose-configured computers, intelligent switches, etc.

In particular, a primary router 28a is in communication with the IPTV video head-end 24 over a local area network for receiving the broadcast channels encoded using H.264. The primary router 28a is in communication with two other routers 28b and 24c over IP tunnels 36a and 36b respectively. The router 28b is also in communication with another router 28d over an IP tunnel 36c. Similarly, the router 28c is also in communication with another router 28e over an IP tunnel 36d. The routers 28d and 24e are in communication with one another over an IP tunnel 36e. All of the routers 28 are purpose-configured to behave in a manner described herein.

IP tunnels 36 are created between pairs of routers 28 using generic routing encapsulation, a tunneling protocol developed by Cisco that can encapsulate a wide variety of protocol packet types inside IP tunnels, creating a virtual point-to-point link between the routers 28 over the IP data communications network 32. More details about generic routing encapsulation can be found in RFC 1701, RFC 1702 and RFC 2890, as published by the Internet Engineering Task Force (“IETF”), the contents of which are incorporated herein by reference. IP tunnels 36 can, and typically do, pass through one or more other intermediate routing devices. The routers 28 are configured via configuration information that is stored in the NVRAM to establish the IP tunnels 36. The firmware of the routers 28 reads the configuration information and its behavior is modified accordingly. In particular, the configuration information, amongst other things, specifies that the router 28 is to enable IP multicast routing, create interfaces for IP tunnels 36 with adjacent routers 28 (i.e., the IP addresses of the interfaces and their PIM mode), create Ethernet interfaces (IP addresses, virtual local area networks), define the default gateway, use certain routing protocols, and define static routes.

In effect, the routers 28 form a redundant network, where there are at least two paths between each pair of routers 28. The routers 28 are connected in a ring structure, as shown in FIG. 1. Each router 28 has at least two network interfaces coupled to two other routers 28. For example, router 28d is coupled to router 28b via a first interface and to router 28e via a second interface.

Each of the routers 28b to 24e is also in communication with digital subscriber line access multiplexer (“DSLAM”) farms 40a to 40d respectively. DSLAM farms 40 are arrays of network devices located in the telephone exchanges of the telecommunications service provider operating the IP data communications network 32 that connect multiple customer digital subscriber lines (“DSLs”) to a high-speed IP data communications network, such as IP data communications network 32, using multiplexing techniques. The DSLAM farms 40 allow existing telephone lines to make faster data connections to data communications networks. In addition, the DSLAM farms 40 have at least one processing unit and non-volatile storage.

A number of receiver devices 44 are in communication with the DSLAM farms 40 over plain old telephone service (“POTS”) lines and DSL modems (not shown). Those skilled in the art will appreciate that the number of receiver devices 44 are not representative of real-world scenarios, but merely illustrative. As shown, receiver devices 44a to 44c are in communication with DSLAM farm 40a, receiver devices 44d to 44f are in communication with DSLAM farm 40b, receiver devices 44g to 44i are in communication with DSLAM farm 40c and receiver devices 44j to 44l are in communication with DSLAM farm 40d. As receiver device 44a is coupled to DSLAM farm 40a, which is in communication with the IP data communication network 32 via router 28b, it is said that receiver device 44a accesses the streaming media through router 28b.

The routers 28 are coupled together in a ring formation.

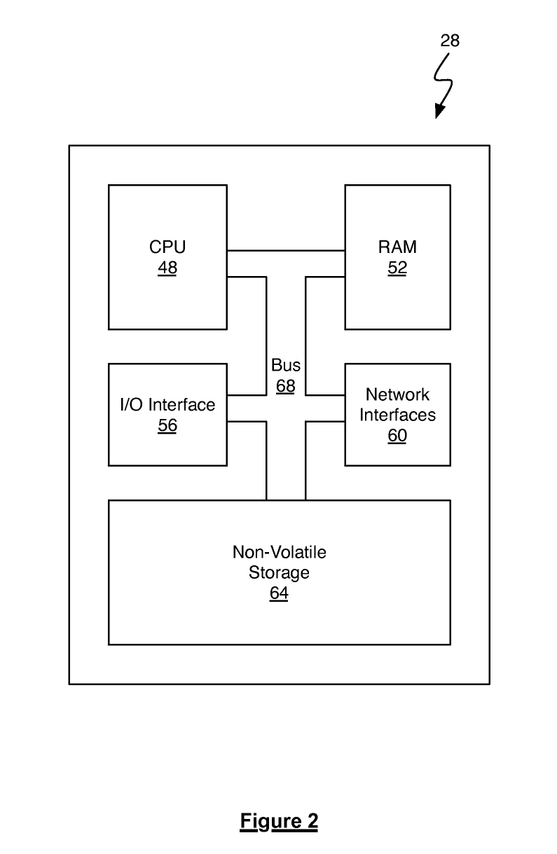

FIG. 2 shows various physical elements of a routing device 28 in greater detail. As shown, the routing device 28 has a number of physical and logical components, including a central processing unit (“CPU”) 48, random access memory (“RAM”) 52, an input/output (“I/O”) interface 56, a set of network interfaces 60, non-volatile storage 64, and a local bus 68 enabling the CPU 48 to communicate with the other components. The CPU 48 executes an operating system that is stored in non-volatile storage 76 and executed in RAM 60. RAM 60 provides relatively-responsive volatile storage to the CPU 48. The I/O interface 56 allows for input to be received from one or more devices, such as a computer directly coupled to the router 28. The network interfaces 60 permit communications with other routers 28 via IP tunnels 36, with DSLAM farms 40 and with the IPTV video head-end 24, in the case of the primary router 28a. The non-volatile storage 64 includes electrically-erasable programmable read-only memory (“EEPROM”) that stores the firmware that governs the operation of the router 28, and non-volatile random access memory (“NVRAM”) for storing configuration information. The configuration information is read by the firmware and alters the behavior of the router 28. During operation of the router 28, the components of the firmware and the configuration information may be retrieved from the non-volatile storage 64 and placed in RAM 48 to facilitate execution.

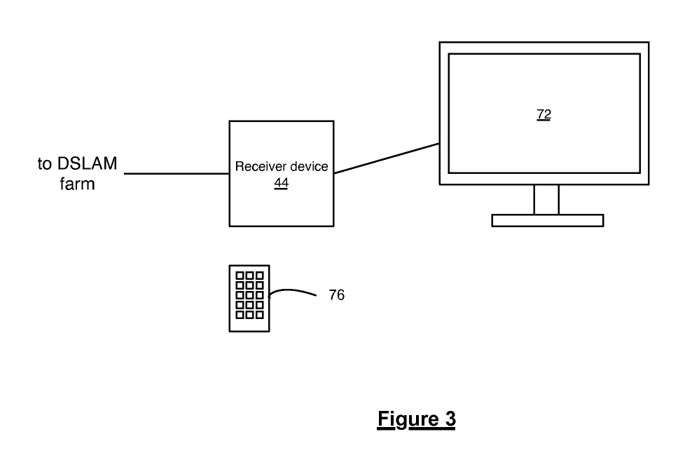

FIG. 3 shows a receiver device 44 and its operating environment in greater detail. The receiver device 44 is a set-top box that is in communication with a DSLAM farm 40 via a DSL modem (not shown), and outputs video and audio signals to a television 72. The DSL modem modulates and demodulates communications with the DSLAM farm 40 via POTS into IP for communication to and from the receiver device 44. A remote control 76 transmits infrared light signals to the receiver device 44 in response to a user pressing buttons thereof for switching channels, adjusting the volume, etc.

The receiver device 44 sends requests for channels via the Internet Group Management Protocol (“IGMP). IGMP is a typical IP multicast protocol that provides a means to send a single media stream to a group of recipients on a computer network. An IP multicast group address is used by sources and the receivers to send and receive multicast messages. The primary router 28a that acts on behalf of the broadcast source, the IPTV video head-end 24, uses the IP multicast group address as the IP destination address in the data packets for the broadcast. The receiver devices 44 use this IP multicast group address to inform the network that they are interested in receiving packets sent to that group.

In the absence of the purpose-configured routers 28, when a receiver device 44 is tuned into a channel, the receiver device 44 generates an IGMP request for that channel. In response, the primary router 28a streams the channel to the receiver device 44. The delay between tuning into a channel on a receiver device 44 and receiving the channel can be two or more seconds in some scenarios. When a user is scanning (or “flipping”) through channels to see what content is available on the various channels, such a delay can be undesirable.

Using the system 20, media broadcasts representing channels can be streamed proactively to other routers 28 from the primary router 28a, regardless of whether each router 28 provides access to receiver devices 44 that are tuned into those channels. As all routers 28 are already receiving these channels, requests from receiver devices 44 for these channels can be served quickly with the streamed channel. Given the ever-increasing number of channels that are available through some broadcasters, it may be undesirable to stream all of the channels to all of the routers 28 all of the time. By selectively streaming a subset of all available channels to the router devices 28 proactively, channels that may be popular, for example, can be received after tuning in on a receiver device 44 with significantly less delay without having to proactively broadcast all channels to all of the routers 28. Some channels identified as being popular, or otherwise desirable to provide to new viewers with less delay upon tuning in, are placed into one or more groups of pools that are proactively broadcast to the routers 28. As not all channels are proactively broadcast to all the routers 28, bandwidth usage is conserved.

When a user tunes his receiver device 44 into a channel using the system 20, the receiver device 44 generates an IGMP request for that channel. Each channel is mapped onto an IP multicast address in the system 20. The IP multicast addresses range from 239.255.1.1 to 239.255.254.254, and can be written in the form 239.255.x.y, where x and y are the last two segments, referred to as octets since they represent eight bits of data. Using this convention, the system 20 can accommodate up to 254²=64,516 channels. The receiver devices 44 are configured to generate IGMP requests addressed to the IP multicast address assigned to the channel.

The receiver device 44 transmits the IGMP request to the DSLAM farm 40. All IGMP communications are directed through a particular DSLAM farm 40 and router 28 first. For example, an IGMP request from receiver device 44j is passed to DSLAM farm 40d. The DSLAM farm 40 adds the receiver device 44 to the particular IP multicast group.

If the DSLAM farm 40 that received the IGMP request from the receiver device 44 is already receiving the channel, the DSLAM farm 40 commences streaming the channel to the receiver device 44 immediately. The DSLAM farm 40 may be already receiving a channel if another receiver device 44 connected to it is tuned into that channel. If, instead, the DSLAM farm 40 receiving the IGMP request from the receiver device 44 is not already receiving the requested channel, it adds the receiver device 44 to the IGMP group for that channel, and forwards the IGMP request to the router 28 through which it accesses the IP data communications network 32.

Additionally, the DSLAM farm 40 transmits the IGMP request to the router 28 to which it is connected. Upon receipt of the IGMP request, the router 28 registers the IGMP request. If the router 28 is already receiving the channel corresponding to the IGMP request, it commences to stream the broadcast to the DSLAM farm 40 for retransmission to the receiver device 44 requesting the channel. The router 28 may be receiving the channel for one of two reasons: (a) the channel is part of a pool of channels that is streamed to all routers 28, or (b) the channel is being received by the router 28 en route to a receiver device 44 that is already tuned into the channel (that is, the router 28 is along a path between the broadcast source and the receiver device 44).

If, instead, the router 28 is not receiving the channel, the router 28 forwards the IGMP request to the primary router 28a via the IP tunnels 36 and other routers 28. Upon receipt of the IGMP request, the primary router 28a streams the channel to the router 28 that originally received the IGMP request via the IP tunnels 36 and other intermediate routers 28 along the path through the system 20 between the broadcast source and the receiver device 44. The router 28 then streams the channel to the DSLAM farm 40, which, in turn, streams the channel to the receiver device 44 that requested it. Thus, referring to FIG. 1, if receiver device 44j requests a channel that is not in any pool, the channel may be streamed from the IPTV video head-end 24, through the primary router 28a, through IP tunnel 36b to router 28c, then through IP tunnel 36d to router 28e and finally to receiver device 44j via DSLAM 40d. As the channel is being transmitted through routers 28c and 28e, they can, in turn, provide the streamed channel directly to receiver devices 44 that access broadcasts through them. Thus if a second receiver device 44e requests the same channel, the router 28c can quickly reply with the streamed channel.

When a receiver device 44 tunes out of a channel as a result of the user changing channels, or is turned off by the power button, the receiver device 44 transmits an IGMP leave message to the DSLAM farm 40 to which it is connected. As will be understood, when a receiver device 44 changes channels from a first to a second, an IGMP leave message for the first channel is transmitted by the receiver device 44 together with an IGMP request for the second channel. Upon receipt of an IGMP leave message, the DSLAM farm 40 removes the receiver device 44 from the IGMP multicast group for the channel left and forwards the IGMP leave message to the router 28. The router 28, upon receipt and registration of an IGMP leave message, checks to see if the channel left is in one of the pools streamed to all routers 28. If the channel is in a pool, the router 28 does nothing further. If, instead, the channel is not in a pool, the router 28 polls the DSLAM farm 40 with an IGMP membership request to see if there are any receiver devices 44 remaining in the IGMP multicast group for that channel. If there is at least one receiver device 44 in the IGMP multicast group, the router 28 does nothing. If, instead, there are no remaining receiver devices 44 in the IGMP multicast group, the router 28 transmits the IGMP leave message to the primary router 28a. If the router 28 is no longer along a path between the broadcast source and other receiver devices 44 tuned into the channel, the router 28 will no longer receive the channel. If, instead, the channel being left is in a pool, the router 28 simply stops streaming the channel to the DSLAM farm 40 to which the receiver device 44 that transmitted the IGMP leave message is connected.

The system 20 streams channels that are in one of two pools proactively to all routers 28: a multicast constant pool and a multicast elected pool. The multicast constant pool includes a set of channels that are specified by a system administrator for streaming proactively to all routers 28 regardless of viewership. Channels may be placed into the multicast constant pool if they are expected to be popular, perhaps as a result of the content that they broadcast or as a result of their channel number. That is, if a channel is between two highly-viewed channels, it may be desirable to proactively stream that channel to make the system 20 seem more responsive. Channels may also be placed in the multicast constant pool as a result of an arrangement. Those skilled in the art will appreciate that there are other circumstances under which it is desirable to proactively stream a channel to the routers 28.

In contrast, the multicast elected pool includes channels that are not in the multicast constant pool and that are determined to be “popular” based on audience statistics that are captured and analyzed. The popularity of channels in the current embodiment is determined periodically based on viewing statistics over a time interval, with those channels that meet one or more thresholds and are not in the multicast constant pool being added to the multicast elected pool. The channels in the multicast elected pool are then proactively streamed to all the routers 28, along with the channels in the multicast constant pool, until the channels in the multicast elected pool are re-determined at a later time. As subsequent determinations of which channels are popular according to the viewing statistics captured during subsequent five-minute time intervals are made, the multicast elected pool is configured to include the channels deemed to be popular at those later times. In this manner, the system 20 dynamically adds and removes channels from the multicast elected pool that is streamed proactively to all routers 28 as their popularity rises and falls.

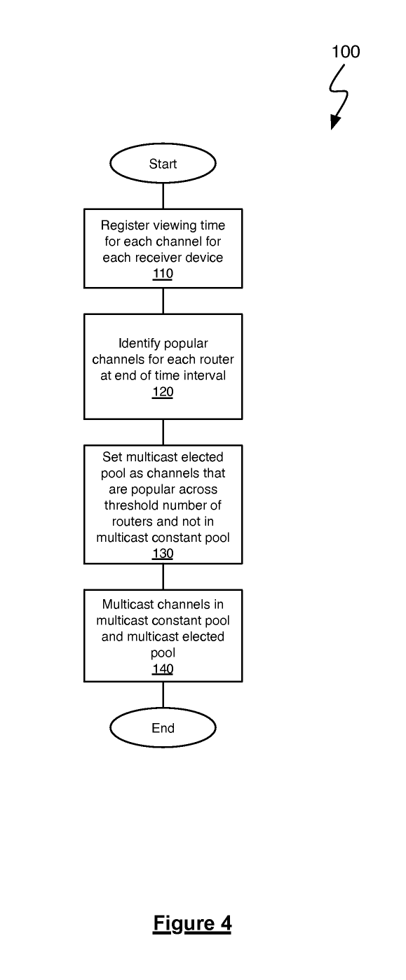

FIG. 4 is a flowchart of the method for streaming media broadcasts over a data communications network using the system 20 shown in FIG. 1 generally at 100. The method 100 commences with the registration of viewing time for each channel for each receiver device 44 during the time interval (110). During the course of the five-minute time interval, each router 28 registers how long each receiver device 44 connected to it was viewing each channel in a local array, ALxyc. The three dimensions of this array correspond to the x octet of the IP address assigned to a channel, the y octet of the IP address assigned to a channel and the customer number. Each receiver device 44 is assigned a unique customer number by the IPTV video head-end 24 when the receiver device 44 connects for the first time. Each element in the array corresponds to the number of seconds that the particular receiver device 44 was tuned into the particular channel. Thus, AL(2,14,423) is a register of how many seconds the receiver device 44 with a customer ID of “423” was tuned into the channel mapped to IP address 239.255.2.14 during the time interval. At the start of each time interval, each element of ALxyc is set to zero so that it only registers viewing time during the current time interval.

The router 28 determines how long a receiver device 44 is tuned into a channel by logging when an IGMP request for a channel is received by the receiver device 44 and then, upon subsequently receiving an IGMP leave message for that channel from the same receiver device 44 or upon reaching the end of the time interval, adding the time difference to the corresponding element in ALxyc. The time added to ALxyc for a receiver device 44 that was tuned into a channel during a time interval, represented by T_{xyc}, is determined as follows:

T_{xyc=min(}t_{TIend},tₗₑₐᵥₑ)−max(t_{TIstar}, t_{request}),

where t_{TIend} is the absolute time at the end of the time interval, t_{TIstart} is the absolute time at the start of the time interval, tₗₑₐᵥₑ is the absolute time when the router 28 received an IGMP leave message from the receiver device 44 for the particular channel (if received before the end of the time interval) and t_{request} is the absolute time when the router 28 received an IGMP request from the receiver device 44 for the particular channel (if received). If a receiver device 44 changes channels multiple times during a time interval (i.e., transmits multiple IGMP leave messages and IGMP requests), T_{xyc} is calculated and added to ALxyc each time an IGMP leave message is received and at the end of the time interval, if the receiver device 44 is deemed to be tuned into a channel at that time. If a receiver device 44 is tuned into a channel at the end of a time interval, T_{xyc} is determined at the end of the time interval.

At the end of each time interval, each router 28 identifies popular channels at the end of the time interval (120). At time-synchronized regular time intervals (in particular, every five minutes on the hour), each router 28 determines, for each channel, if at least a threshold number of receiver devices 44 accessing the broadcasts through to the router 28 were tuned into the channel for at least a threshold number of seconds during that time interval.

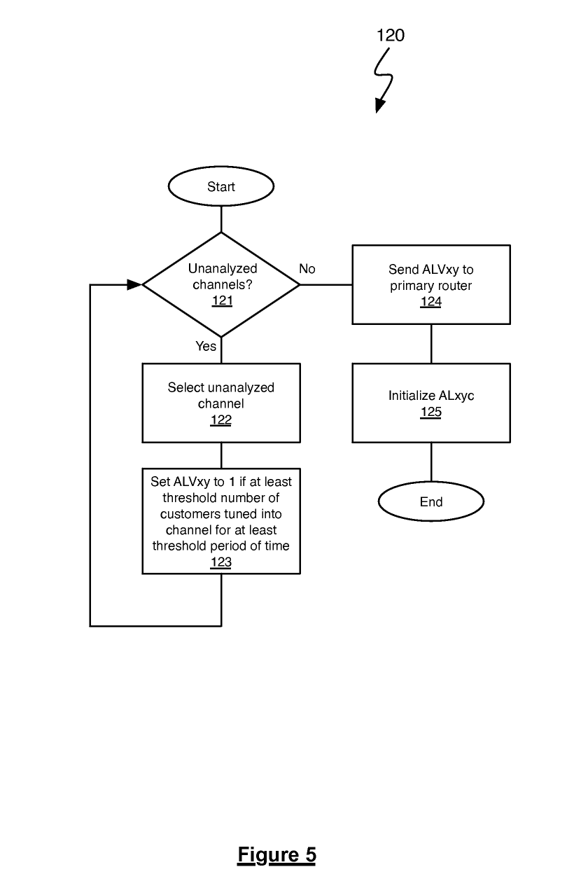

FIG. 5 shows the determination of which channels are popular for a time interval in greater detail. The router 28 determines if there are unanalyzed channels (121). If there are, an unanalyzed channel is selected (122). The router 28 then determines that the selected unanalyzed channel is popular if at least a threshold number of receiver devices 44 were tuned into the selected channel for at least a threshold period of time during the time interval (123). The router 28 maintains a second counter array, ALVxy, that represents whether each channel is popular according to the statistics captured via ALxyc during a time interval. Thus, ALV(2,14) is a binary register (having values of 1 or 0) of whether the channel mapped to IP address 239.255.2.14 is deemed to be popular or not for the time interval being analyzed at that time at a particular router 28.

The threshold number of receiver devices 44, represented by THR_{dev}, can be set as a constant value for each router 28 or as a value corresponding to a ratio of the number of receiver devices 44 accessing broadcasts through the router 28. The threshold period of time, represented by THRₜᵢₘₑ, is a constant value across all routers 28. Thus, ALVxy is a binary value (i.e., 0 or 1), and is calculated as follows:

$${ALV}_{xy} = ( {\sum }_{c = 1}^{n} ( ALxyc > {THR}_{time} ) ) > {THR}_{dev} .$$

Upon calculating ALVxy for a channel, the router 28 returns to 121, at which it determines if there are unanalyzed channels, thus calculating ALVxy for every channel. If it is determined that there are no remaining unanalyzed channels at 121, the router 28 sends ALVxy to the primary router 28a (124). Upon successful transmission of ALVxy, the router 28 initializes ALxyc (125). In order to initialize this array, each element in the array is zeroed out. With the initialization of ALxyc, the identification of popular channels by the router 28 ends.

Referring again to FIG. 4, upon identifying popular channels at each router 28, the multicast elected pool is set to include channels that are popular across a threshold number of routers and not in the multicast constant pool (130).

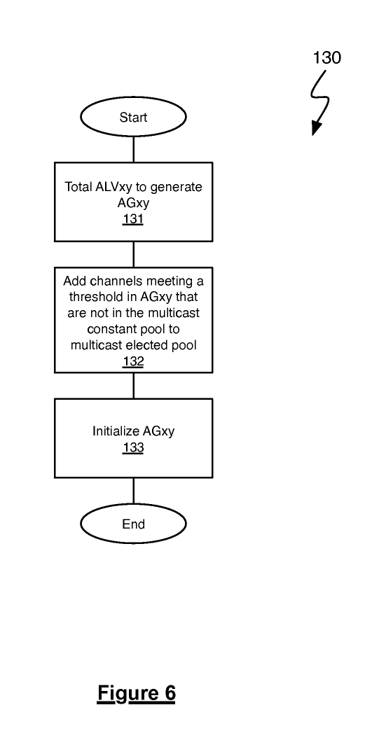

FIG. 6 shows the setting of the multicast elected pool in greater detail. As each ALVxy is received from each router 28, the primary router 28a totals them to generate a global vote array, AGxy (131). The primary router 28a maintains AGxy for tallying votes by each router 28 for the popularity of each channel. This array registers the number of routers 28 that deemed each channel to be popular. Thus, AG(2,14) is a register of how many routers 28 deemed the channel mapped to IP address 239.255.2.14 to be popular. As the primary router 28a receives the ALVxy array from each router 28, it adds the results to AGxy.

Upon receiving all of the ALVxy arrays from each router 28 and adding them to AGxy, the primary router 28a then adds channels meeting a threshold in AGxy that are not in the multicast constant pool to the multicast elected pool (132). The primary router 28a determines which channels have values in AGxy, corresponding to the number of votes from the routers 28, that are at least equal to a threshold, THRᵣₒᵤₜₑᵣₛ, and adds those that are not in the multicast constant pool to the multicast elected pool, replacing the contents of the previously-determined multicast elected pool. Upon determining which channels are in the multicast elected pool, the primary router 28 initializes AGxy (133) by zeroing out its values, thus preparing it for the tally at the end of the subsequent time interval.

Returning again to FIG. 4, when the multicast elected pool has been determined, the primary router 28a multicasts channels in the multicast constant pool and the multicast elected pool to all routers 28 (140). In order to better utilize both the up- and down-link bandwidth of each IP tunnel 36, the primary router 28a streams one half of the channels in the pools in one direction along the ring of routers 28, and the other half of the channels in the pools in the opposite direction. That is, the primary router 28a streams some channels in the pools first to router 28b for subsequent transmission to routers 28e, 28d and 28c, and streams the balance of the channels in the pools first to router 28c for subsequent transmission to routers 28d, 28e and 28b.

This method 100 is reiterated for each time interval. Thus, as soon as each router 28 determines and submits its votes for the popularity of each channel, it begins registering the viewing time for each channel by each receiver device 44 for the next time interval. As the constituency of the multicast elected pool is changed each time interval, the primary router 28a generally continues to stream channels that remain in the multicast elected pool in the direction along the ring of routers 28 and selectively streams channels newly-added to the multicast elected pool in one of the two directions around the ring of routers 28 in an effort to keep traffic in either direction as balanced as possible.

In some cases, the routers 28 can fail to receive IGMP leave messages from receiver devices 44 that are no longer tuned into a channel. This can occur when a receiver device 44 loses power before being turned off via the power button (such as during a black-out or via having its power cut). To compensate for such circumstances, the routers 28 discard logged channel join events older than one day or some other period of time periodically.

While the invention has been described with specificity to a television broadcasting, other types of implementations will occur to those of skill in the art. For example, online learning can be streamed using the invention. Other exemplary applications include audio broadcasts and screencasts.

While the system described above is shown operating over a private network, those skilled in the art will appreciate that the system can operate over a public network, such as the Internet.

The time interval length can be varied as desired. In some cases, it may be more desirable to have a shorter time interval, such as, for example, one minute, where in other cases it can be desirable to have a time interval of one day or more. Further, the popularity of media broadcasts can be determined using a moving time interval.

While the popularity of media broadcasts are determined using a set of thresholds, those skilled in the art will appreciate that other approaches can be employed. For example, viewer statistics can be compiled centrally and the popularity of a channel can be determined using a single threshold.

The thresholds can be static or dynamic. For example, the thresholds can vary based on the number of media broadcasts that are streamed to all routers. If the multicast constant pool is large, it can be desirable to adjust the thresholds to make additions to the multicast elected pool less likely. Where bandwidth cost or availability fluctuates, the determination of the popularity of each media broadcast can be adjusted to result in, for example, fewer media broadcasts being deemed popular when it is desired to consume less bandwidth. In another alternative embodiment, a fixed number of media broadcasts are deemed popular.

In the above embodiment, the popularity of media broadcasts in a time interval determines their proactive streaming to all routing devices in a subsequent time interval. It can be desirable in some circumstances to determine popularity for a media broadcast in a time interval and then proactively stream that media broadcast at a later time interval. For example, if there is a pattern of viewing for a channel that indicates that the channel is popular on Tuesday between 8 pm and 9 pm, it can be desirable to proactively stream that media broadcast the following Tuesday between 8 pm and 9 pm.

The statistics can be aggregated by a central device before analysis. In such cases, for example, the popularity of media broadcasts can be determined by looking at the total time that a broadcast channel is tuned into by all of the receiver devices.

In some cases, such systems can be segregated into subsets of routers, where popularity is determined for a subset of the receiver devices and, if a media broadcast is popular for the subset of routers, but not across all routers, it can be desirable to proactively stream the media broadcast across the subset of routers. Subsets of routers can be defined geographically, demographically, etc.

Other types of receiver devices can be used. For example, personal computers in a cable Internet environment can be used in place of the set-top boxes connecting via DSL described above.

More than one broadcast source can be included. Where two or more broadcast sources are used, they can be made accessible through the same or different routing devices.

Computer-executable instructions or configuration information for implementing the system on a routing device could be provided separately from the computer system, for example, on a computer-readable medium (such as, for example, an optical disk, a hard disk, a USB drive or a media card) or by making them available for downloading over a communications network, such as the Internet.

While the routing devices in the above-described embodiment are single physical routers, it will be appreciated that the routing devices can include two or more physical devices in communication with each other. For example, two server computers can provide the functionality of a router. Additionally, a separate computer coupled to the routing devices can add and remove media broadcasts from the pool(s).

The system can include more than one broadcast source. In an exemplary scenario, each routing device can track usage statistics for all receiver devices for all media broadcasts, and then generate and transmit tallies particular to each broadcast source.

One or more portions of the method may be executed by third parties. For example, a first party can determine the popularity of media broadcasts and inform a second party that is responsible for streaming the media broadcast to receiver devices.

The above-described embodiments are intended to be examples of the present invention and alterations and modifications may be effected thereto, by those of skill in the art, without departing from the scope of the invention that is defined solely by the claims appended hereto.

What is claimed is:

1. A method for streaming media broadcasts over a data communications network, comprising:
analyzing statistics for receiver devices receiving a plurality of media broadcasts from a broadcast source via a set of routing devices over a data communications network to determine which of said media broadcasts are popular, each of said receiver devices accessing said streaming media broadcasts via one of said routing devices;
streaming said popular media broadcasts to all of said routing devices; and
streaming said unpopular media broadcasts to said routing devices along paths between said broadcast source and said receiver devices tuned into said unpopular media broadcasts.

2. The method of claim 1, wherein said analyzing is performed periodically.

3. The method of claim 2, wherein said statistics include the amount of time said receiver devices were tuned into each of said media broadcasts.

4. The method of claim 3, wherein said analyzing comprises:
determining the number of said receiver devices were tuned into each of said media broadcasts for at least a threshold period of time.

5. The method of claim 4, wherein said analyzing further comprises:
registering a vote, for each of said media broadcasts, if the number of said receiver devices tuned into said media broadcast is at least equal to a threshold.

6. The method of claim 5, wherein said registering is performed by said routing devices.

7. The method of claim 6, wherein each of said media broadcasts is deemed popular if the number of votes received from said routing devices for said media broadcast is at least equal to a threshold.

8. The method of claim 1, wherein said routing devices are routers that stream said media broadcasts to other said routers via IP tunnels.

9. The method of claim 8, wherein said IP tunnels are established using general routing encapsulation (“GRE”).

10. The method of claim 8, wherein said routers are arranged in a ring formation.

11. The method of claim 10, wherein said streaming of said popular media broadcasts comprises:
streaming some of said popular media broadcasts in a first direction around said ring formation of routers; and
streaming the balance of said popular media broadcasts in a second direction around said ring formation of routers.

12. The method of claim 1, further comprising:
streaming a subset of said media broadcasts to all of said routing devices regardless of whether said media broadcasts in said subset are popular or unpopular.

13. The method of claim 1, wherein the determination of which of said media broadcasts are popular is adjustable.

14. The method of claim 13, wherein the determination of which of said media broadcasts are popular is adjusted according to available bandwidth.

15. A system for streaming media broadcasts over a data communications network, comprising:
a set of routing devices in communication with each other over said data communications network, said set of routing devices receiving a plurality of media broadcasts from a broadcast source; and
a processing unit executing computer-executable instructions configured for determining if each of said media broadcasts is popular using statistics for receiver devices, each of said receiver devices accessing said streaming media broadcasts via one of said routing devices, streaming said popular media broadcasts to all of said routing devices and streaming said unpopular media broadcasts to said routing devices along paths between said broadcast source and said receiver devices tuned into said unpopular media broadcasts.

16. The system of claim 15, wherein said processing unit determines if each of said media broadcasts are popular periodically.

17. The system of claim 16, wherein said statistics include the amount of time said receiver devices were tuned into each of said media broadcasts.

18. The system of claim 15, wherein each of said media broadcasts is deemed popular if the number of votes received from said routing devices for said media broadcast is at least equal to a threshold.

19. The system of claim 15, wherein said routing devices are routers.

20. The system of claim 19, wherein said routers stream said media broadcasts via IP tunnels between said routers.

21. The system of claim 20, wherein said routers are arranged in a ring formation, and wherein said processing unit streams said popular media broadcasts in a first direction around said ring formation of routers, and streams the balance of said popular media broadcasts in a second direction around said ring formation of routers.

22. The system of claim 15, wherein a subset of said media broadcasts is streamed to all of said routing devices regardless of whether said media broadcasts in said subset are popular or unpopular.

23. The system of claim 15, wherein the determination of which of said media broadcasts are popular is adjustable.

24. The system of claim 23, wherein the determination of which of said media broadcasts are popular is adjusted according to available bandwidth.
